(19) United States
(12) Patent Application Publication
(10) Pub. No.: US 2026/0072312 A1
(43) Pub. Date: Mar. 12, 2026

(54) DISPLAY DEVICE, AND WRISTWATCH-TYPE ELECTRONIC APPARATUS AND VEHICLE INSTRUMENT PANEL INCLUDING THE DISPLAY DEVICE

(71) Applicant: Japan Display Inc., Tokyo (JP)

(72) Inventor: Kazunari TOMIZAWA, Tokyo (JP)

(21) Appl. No.: 19/320,584

(22) Filed: Sep. 5, 2025

(30) Foreign Application Priority Data
Sep. 11, 2024 (JP) 2024-157288

(51) Int. Cl. G02F 1/1335

(52) U.S. Cl. CPC G02F 1/133626; G02F 1/133514; G02F 1/133528

(57) ABSTRACT

According to an aspect, a display device includes: a backlight; a first polarizing plate that transmits light polarized in a first direction; a first liquid crystal display panel; a second liquid crystal display panel overlapping the first liquid crystal display panel with a gap interposed between the first and second liquid crystal display panels; and a second polarizing plate on which transmitted light from the second liquid crystal display panel is incident and that transmits light polarized in a second direction. The backlight has modes with different light emission timings respectively for light emission colors. The first liquid crystal display panel is provided with a first color filter, a second color filter, and a third color filter. The second liquid crystal display panel is not provided with a color filter. No other polarizing plate is provided between the first liquid crystal display panel and the second liquid crystal display panel.

### CROSS-REFERENCE TO RELATED APPLICATION

This application claims the benefit of priority from Japanese Patent Application No. 2024-157288 filed on Sep. 11, 2024, the entire contents of which are incorporated herein by reference.

### BACKGROUND

### 1. Technical Field

What is disclosed herein relates to a display device, and a wristwatch-type electronic apparatus and a vehicle instrument panel including the display device.

### 2. Description of the Related Art

Recently, wristwatch-type electronic apparatuses such as so-called smartwatches have been known. A technology for providing a plurality of display modes by changing the states of two display panels disposed with an air space interposed therebetween is disclosed for use in such a wristwatch-type electronic apparatus (for example, Japanese Patent Application Laid-open Publication No. 2019-008200).

In a configuration in which two display panels are disposed in an overlapping manner, transmittance may decrease as light passes through a plurality of constituent components, resulting in decrease in the luminance of a displayed image. Furthermore, display power efficiency potentially decreases in order to suppress decrease in the luminance of the displayed image.

For the foregoing reasons, there is a need for a display device capable of suppressing decrease in display power efficiency in a configuration including two display panels disposed in an overlapping manner and having a plurality of display modes, and a wristwatch-type electronic apparatus and a vehicle instrument panel including the display device.

### SUMMARY

According to an aspect, a display device includes: a backlight; a first polarizing plate on which direct light from the backlight is incident and that transmits light polarized in a first direction and blocks light polarized in a direction different from the first direction; a first liquid crystal display panel on which transmitted light from the first polarizing plate is incident; a second liquid crystal display panel that overlaps the first liquid crystal display panel with a gap interposed between the first and second liquid crystal display panels and on which transmitted light from the first liquid crystal display panel is incident; and a second polarizing plate on which transmitted light from the second liquid crystal display panel is incident and that transmits light polarized in a second direction different from the first direction and blocks light polarized in a direction different from the second direction. The backlight has a plurality of modes with different light emission timings respectively for a plurality of light emission colors. The first liquid crystal display panel is provided with a first color filter that transmits first light, a second color filter that transmits second light different from the first light, and a third color filter that transmits third light different from the first light and the second light. The second liquid crystal display panel is not provided with a color filter. No other polarizing plate is provided between the first liquid crystal display panel and the second liquid crystal display panel.

According to an aspect, a wristwatch-type electronic apparatus includes the display device.

According to an aspect, a vehicle instrument panel includes the display device.

### BRIEF DESCRIPTION OF THE DRAWINGS

FIG. 1 is a block diagram illustrating an example of a schematic configuration of a meter device, as an example of application of a display device according to an embodiment;

FIG. 2A is a schematic diagram illustrating a first example of a first image displayed on a first liquid crystal display panel;

FIG. 2B is a schematic diagram illustrating a first example of a second image displayed on a second liquid crystal display panel;

FIG. 3A is a schematic diagram illustrating a second example of the first image displayed on the first liquid crystal display panel;

FIG. 3B is a schematic diagram illustrating a second example of the second image displayed on the second liquid crystal display panel;

FIG. 4 is a timing chart illustrating an example of driving patterns of the first liquid crystal display panel, the second liquid crystal display panel, and a backlight in a first mode;

FIG. 5 is a timing chart illustrating an example of driving patterns of the first liquid crystal display panel, the second liquid crystal display panel, and the backlight in a second mode;

FIG. 6 is a schematic diagram illustrating a specific example of the color gamut of the second image in the second mode; and

FIG. 7 is a timing chart illustrating an example of driving patterns of the first liquid crystal display panel, the second liquid crystal display panel, and the backlight in a third mode.

### DETAILED DESCRIPTION

Aspects (embodiments) of the present disclosure will be described below in detail with reference to the accompanying drawings. Contents described below in the embodiments do not limit the present disclosure.

Components described below include those that could be easily thought of by the skilled person in the art and those identical in effect. Components described below may be combined as appropriate. What is disclosed herein is only an example, and any modifications that can be easily conceived by those skilled in the art while maintaining the main purpose of the disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

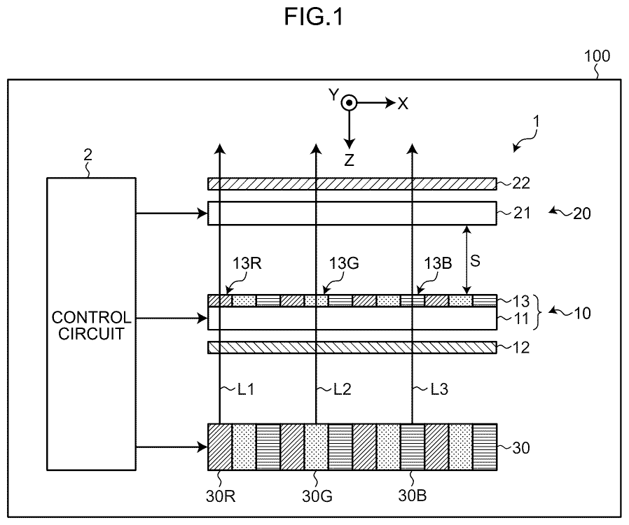

FIG. 1 is a block diagram illustrating an example of a schematic configuration of a meter device, as an example of application of a display device according to an embodiment. Examples of this meter device 100 include a wristwatch-type electronic apparatus such as a smartwatch, and an instrument panel installed in front of the driver seat of a vehicle such as an automobile. The meter device 100 includes a display device 1, and a control circuit 2 configured to control constituent components of the display device 1.

The display device 1 includes, as main constituent components, a first liquid crystal display panel 10 that displays a first image, a second liquid crystal display panel 20 that displays a second image, and a backlight 30. The control circuit 2 performs image display control by synchronizing the first liquid crystal display panel 10, the second liquid crystal display panel 20, and the backlight 30.

Direct light from the backlight 30 is incident on the first liquid crystal display panel 10.

The second liquid crystal display panel 20 is disposed with a gap S interposed between the first liquid crystal display panel 10 and the second liquid crystal display panel 20. The light transmitted through the first liquid crystal display panel 10 is incident on the second liquid crystal display panel 20.

In the present disclosure, the first liquid crystal display panel 10 and the second liquid crystal display panel 20 are transmissive liquid crystal display panels. The first liquid crystal display panel 10 and the second liquid crystal display panel 20 overlap when viewed in a sight line direction (Z direction) of a user of the meter device 100.

In the display device 1 according to the embodiment, the first liquid crystal display panel 10 includes a liquid crystal layer 11 and a color filter 13. The color filter 13 is provided between a first polarizing plate 12 and the second liquid crystal display panel 20. The liquid crystal layer 11 is provided between the first polarizing plate 12 and the color filter 13.

In the display device 1 according to the embodiment, the second liquid crystal display panel 20 includes a liquid crystal layer 21. The second liquid crystal display panel 20 is provided between a second polarizing plate 22 and the first liquid crystal display panel 10. Unlike the first liquid crystal display panel 10, the second liquid crystal display panel 20 is not provided with a color filter.

The first polarizing plate 12 and the second polarizing plate 22 are disposed in a state (cross Nicol) in which their transmission axes are orthogonal to each other with respect to incident light. In the display device 1 according to the present disclosure, no polarizing plate is provided between the first liquid crystal display panel 10 and the second liquid crystal display panel 20.

The first polarizing plate 12 is an optical member that transmits light polarized in a first direction and blocks light polarized in a direction different from the first direction. Specifically, the first polarizing plate 12 is, for example, a linear polarizing plate having a transmission axis in a Y direction.

The second polarizing plate 22 is an optical member that transmits light polarized in a second direction different from the first direction and blocks light polarized in a direction different from the second direction. Specifically, the second polarizing plate 22 is, for example, a linear polarizing plate having a transmission axis in an X direction.

The color filter 13 includes a first color filter 13R that transmits a first light (for example, red light), a second color filter 13G that transmits second light (for example, green light) different from the first light, and a third color filter 13B that transmits third light (for example, blue light) different from the first light and the second light.

The backlight 30 includes a first light source 30R, a second light source 30G, and a third light source 30B. The first light source 30R, the second light source 30G, and the third light source 30B emit light under control of the control circuit 2. The first light source 30R, the second light source 30G, and the third light source 30B are, for example, light sources including light emitting elements such as light emitting diodes (LEDs), but are not limited thereto and may be any light sources with controllable light emission timings. In the present disclosure, the light emission color (first color) of the first light source 30R is red (R), the light emission color (second color) of the second light source 30G is green (G), and the light emission color (third color) of the third light source 30B is blue (B).

The first light source 30R irradiates the first liquid crystal display panel 10 with light L1 in the first color. The light L1 emitted from the first light source 30R passes through the liquid crystal layer 11 of the first liquid crystal display panel 10, the first color filter 13R, and the second liquid crystal display panel 20 in this order, before reaching the viewpoint of the user.

The second light source 30G irradiates the first liquid crystal display panel 10 with light L2 in the second color. The light L2 emitted from the second light source 30G passes through the liquid crystal layer 11 of the first liquid crystal display panel 10, the second color filter 13G, and the second liquid crystal display panel 20 in this order, before reaching the viewpoint of the user.

The third light source 30B irradiates the first liquid crystal display panel 10 with light L3 in the third color. The light L3 emitted from the third light source 30B passes through the liquid crystal layer 11 of the first liquid crystal display panel 10, the third color filter 13B, and the second liquid crystal display panel 20 in this order, before reaching the viewpoint of the user.

An image output region of the first liquid crystal display panel 10 and an image output region of the second liquid crystal display panel 20 overlap when viewed in the sight line direction (Z direction) in which the display device 1 is viewed from the viewpoint of the user. Accordingly, the first image displayed on the first liquid crystal display panel 10 and the second image displayed on the second liquid crystal display panel 20 are visually recognized in an overlapping state by a viewer.

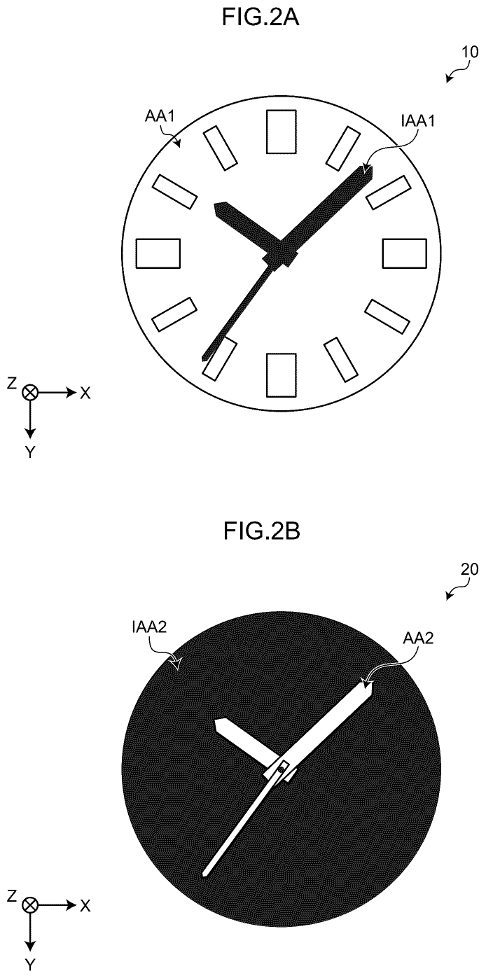

FIG. 2A is a schematic diagram illustrating a first example of the first image displayed on the first liquid crystal display panel. FIG. 2B is a schematic diagram illustrating a first example of the second image displayed on the second liquid crystal display panel. The first example illustrated in FIGS. 2A and 2B exemplifies an aspect in which the display device 1 according to the embodiment is applied to a smartwatch.

The first example illustrated in FIGS. 2A and 2B exemplifies an aspect in which a face of an analog clock (or an analog watch) is displayed as the first image displayed on the first liquid crystal display panel 10, and clock hands including an hour hand, a minute hand, and a second hand of the analog clock are displayed as the second image displayed on the second liquid crystal display panel 20.

As illustrated in FIGS. 2A and 2B, when viewed in at least the sight line direction (Z direction) in which the first liquid crystal display panel 10 and the second liquid crystal display panel 20 are visually recognized in an overlapping manner by the user, a display region AA1 overlaps a non-display region IAA2, and a non-display region IAA1 overlaps a display region AA2. The display region AA1 is a region in which the first image is displayed in the first liquid crystal display panel 10. The non-display region IAA2 is a region in which image display is not performed in the second liquid crystal display panel 20. The non-display region IAA1 is a region in which image display is not performed in the first liquid crystal display panel 10. The display region AA2 is a region in which the second image is displayed in the second liquid crystal display panel 20.

Light having passed through the first image displayed in the display region AA1 of the first liquid crystal display panel 10 passes through the non-display region IAA2 of the second liquid crystal display panel 20 and reaches the viewpoint of the user. Accordingly, the first image (in this example, the face of the analog clock) displayed in the display region AA1 of the first liquid crystal display panel 10 is visually recognized by the user.

Light having passed through the non-display region IAA1 of the first liquid crystal display panel 10 passes through the second image displayed in the display region AA2 of the second liquid crystal display panel 20 and reaches the viewpoint of the user. Accordingly, the second image (in this example, the clock hands of the analog clock) displayed in the display region AA2 of the second liquid crystal display panel 20 is visually recognized by the user.

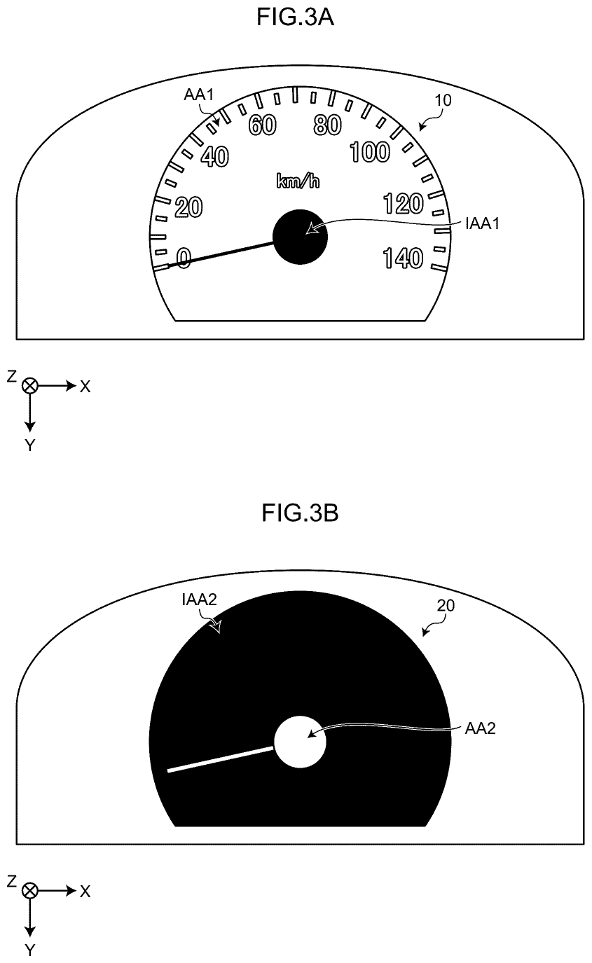

FIG. 3A is a schematic diagram illustrating a second example of the first image displayed on the first liquid crystal display panel. FIG. 3B is a schematic diagram illustrating a second example of the second image displayed on the second liquid crystal display panel. The second example illustrated in FIGS. 3A and 3B exemplifies an aspect in which the display device 1 according to the embodiment is applied to a vehicle instrument panel.

The second example illustrated in FIGS. 3A and 3B exemplifies an aspect in which a face of a speedometer of an automobile is displayed as the first image displayed on the first liquid crystal display panel 10, and a pointer of the speedometer of the automobile is displayed as the second image displayed on the second liquid crystal display panel 20.

As illustrated in FIGS. 3A and 3B, when viewed in at least the sight line direction (Z direction) in which the first liquid crystal display panel 10 and the second liquid crystal display panel 20 are visually recognized in an overlapping manner by the user, the display region AA1 overlaps the non-display region IAA2, and the non-display region IAA1 overlaps the display region AA2. The display region AA1 is a region in which the first image is displayed in the first liquid crystal display panel 10. The non-display region IAA2 is a region in which image display is not performed in the second liquid crystal display panel 20. The non-display region IAA1 is a region in which image display is not performed in the first liquid crystal display panel 10. The display region AA2 is a region in which the second image is displayed in the second liquid crystal display panel 20.

Light having passed through the first image displayed in the display region AA1 of the first liquid crystal display panel 10 passes through the non-display region IAA2 of the second liquid crystal display panel 20 and reaches the viewpoint of the user. Accordingly, the first image (in this example, the face of the speedometer of the automobile) displayed in the display region AA1 of the first liquid crystal display panel 10 is visually recognized by the user.

Light having passed through the non-display region IAA1 of the first liquid crystal display panel 10 passes through the second image displayed in the display region AA2 of the second liquid crystal display panel 20 and reaches the viewpoint of the user. Accordingly, the second image (in this example, the pointer of the speedometer of the automobile) displayed in the display region AA2 of the second liquid crystal display panel 20 is visually recognized by the user.

In the above-described configuration of the display device 1 according to the embodiment, since the gap S is interposed between the first liquid crystal display panel 10 and the second liquid crystal display panel 20, a stereoscopic composite image constituted by the first image displayed on the first liquid crystal display panel 10 and the second image displayed on the second liquid crystal display panel 20 is visually recognized by the user.

In the display device 1 according to the present disclosure, it is possible to provide a plurality of modes by changing the light emission color of the backlight 30 and varying the light emission timings of the respective light emission colors. The following describes examples of variation in the light emission color and light emission timing of the backlight.

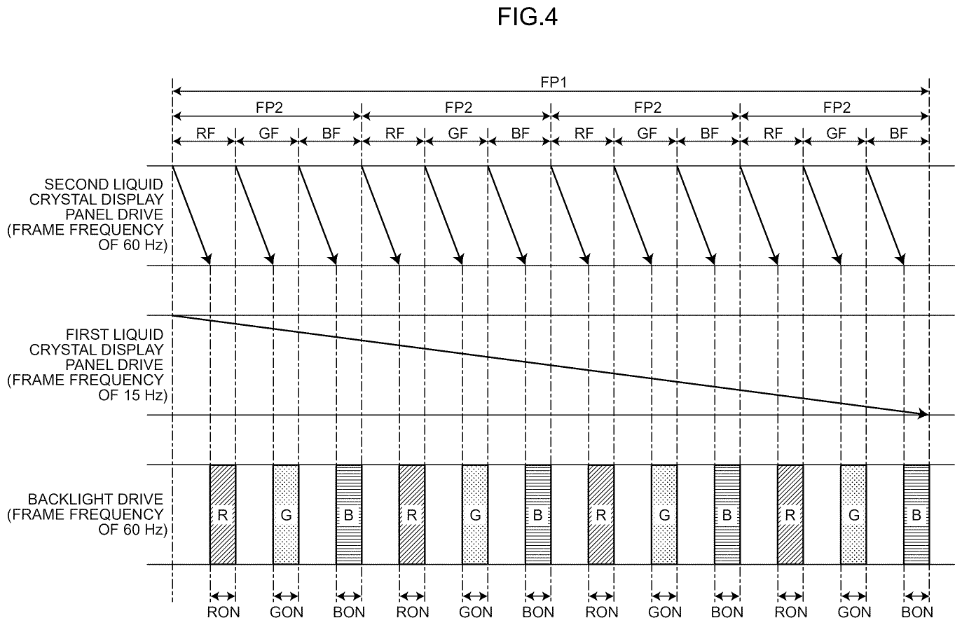

FIG. 4 is a timing chart illustrating an example of driving patterns of the first liquid crystal display panel, the second liquid crystal display panel, and the backlight in a first mode.

In the first mode illustrated in FIG. 4, each frame period FP1 during which the first image is displayed on the first liquid crystal display panel 10 includes a plurality of frame periods FP2 during each of which the second image is displayed on the second liquid crystal display panel 20. FIG. 4 illustrates an example in which each frame period FP1 during which the first image is displayed on the first liquid crystal display panel 10 is time-divided into four frame periods FP2 during each of which the second image is displayed on the second liquid crystal display panel 20. In FIG. 4, the frame frequency of the first liquid crystal display panel 10 is set to 15 Hz, and the frame frequency of the second liquid crystal display panel 20 is set to 60 Hz. Each frame period FP1 of the first liquid crystal display panel 10 is set to 66.7 ms, and each frame period FP2 of the second liquid crystal display panel 20 is set to 16.7 ms. The frame frequency of the first liquid crystal display panel 10 is not limited to 15 Hz. In addition, the frame frequency of the second liquid crystal display panel 20 is not limited to 60 Hz.

Moreover, in the first mode illustrated in FIG. 4, each frame period FP2 during which the second image is displayed on the second liquid crystal display panel 20 is time-divided into a first subframe period (first period) RF, a second subframe period (second period) GF, and a third subframe period (third period) BF. The first subframe period (first period) RF, the second subframe period (second period) GF, and the third subframe period (third period) BF are each set to 5.6 ms.

During the first subframe period (first period) RF, the control circuit 2 performs image data writing corresponding to the first color (red (R)) of the second image to be displayed on the second liquid crystal display panel 20, and causes the first light source 30R of the backlight 30 to emit light during a light emission period RON of the first subframe period (first period) RF.

During the second subframe period (second period) GF, the control circuit 2 performs image data writing corresponding to the second color (green (G)) of the second image to be displayed on the second liquid crystal display panel 20, and causes the second light source 30G of the backlight 30 to emit light during a light emission period GON of the second subframe period (second period) GF.

During the third subframe period (third period) BF, the control circuit 2 performs image data writing corresponding to the third color (blue (B)) of the second image to be displayed on the second liquid crystal display panel 20, and causes the third light source 30B of the backlight 30 to emit light during a light emission period BON of the third subframe period (third period) BF.

Accordingly, one frame of the second image is displayed on the second liquid crystal display panel 20. Throughout each frame period FP1, the control circuit 2 performs image data writing corresponding to each color of the first image that is displayed on the first liquid crystal display panel 10. Accordingly, one frame of the first image is displayed on the first liquid crystal display panel 10.

In the first mode described above, both the first image displayed on the first liquid crystal display panel 10 and the second image displayed on the second liquid crystal display panel 20 can be displayed in full color (16.77 million colors in the case of 256 gradations).

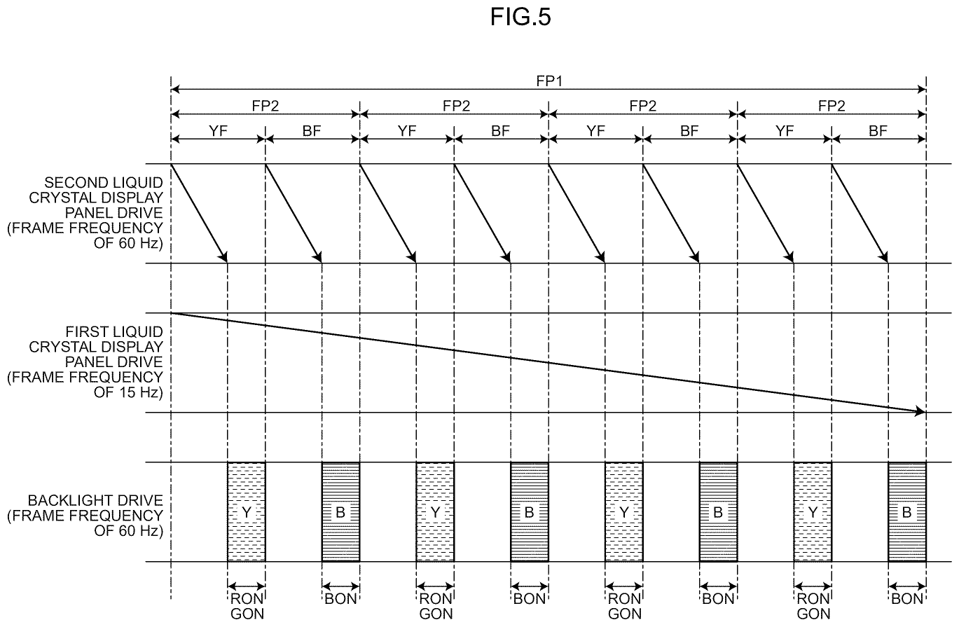

FIG. 5 is a timing chart illustrating an example of driving patterns of the first liquid crystal display panel, the second liquid crystal display panel, and the backlight in a second mode.

In the second mode illustrated in FIG. 5, each frame period FP1 during which the first image is displayed on the first liquid crystal display panel 10 includes a plurality of frame periods FP2 during each of which the second image is displayed on the second liquid crystal display panel 20. FIG. 5 illustrates an example in which each frame period FP1 during which the first image is displayed on the first liquid crystal display panel 10 is time-divided into four frame periods FP2 during each of which the second image is displayed on the second liquid crystal display panel 20. In FIG. 5, the frame frequency of the first liquid crystal display panel 10 is set to 15 Hz, and the frame frequency of the second liquid crystal display panel 20 is set to 60 Hz. Each frame period FP1 of the first liquid crystal display panel 10 is set to 66.7 ms, and each frame period FP2 of the second liquid crystal display panel 20 is set to 16.7 ms. The frame frequency of the first liquid crystal display panel 10 is not limited to 15 Hz. In addition, the frame frequency of the second liquid crystal display panel 20 is not limited to 60 Hz.

Moreover, in the second mode illustrated in FIG. 5, each frame period FP2 during which the second image is displayed on the second liquid crystal display panel 20 is time-divided into a first subframe period (first period) YF and a second subframe period (second period) BF. The first subframe period (first period) YF and the second subframe period (second period) BF are each set to 8.3 ms.

During the first subframe period (first period) YF, the control circuit 2 performs image data writing corresponding to a composite color (yellow (Y)) of the first color (red (R)) and the second color (green (G)) of the second image to be displayed on the second liquid crystal display panel 20, and causes the first light source 30R and the second light source 30G of the backlight 30 to simultaneously emit light during the light emission periods RON and GON of the first subframe period (first period) YF.

During the second subframe period (second period) BF, the control circuit 2 performs image data writing corresponding to the third color (blue (B)) of the second image to be displayed on the second liquid crystal display panel 20, and causes the third light source 30B of the backlight 30 to emit light during the light emission period BON of the second subframe period (second period) BF.

Accordingly, one frame of the second image is displayed on the second liquid crystal display panel 20.

Throughout each frame period FP1, the control circuit 2 performs image data writing corresponding to each color of the first image that is displayed on the first liquid crystal display panel 10. Accordingly, one frame of the first image is displayed on the first liquid crystal display panel 10.

The light emission color of the backlight 30 during the first subframe period (first period) and the second subframe period (second period) in the second mode may be any of the first color (red (R)), the second color (green (G)), and the third color (blue (B)) or may be a composite color of a plurality of colors among the first color (red (R)), the second color (green (G)), and the third color (blue (B)).

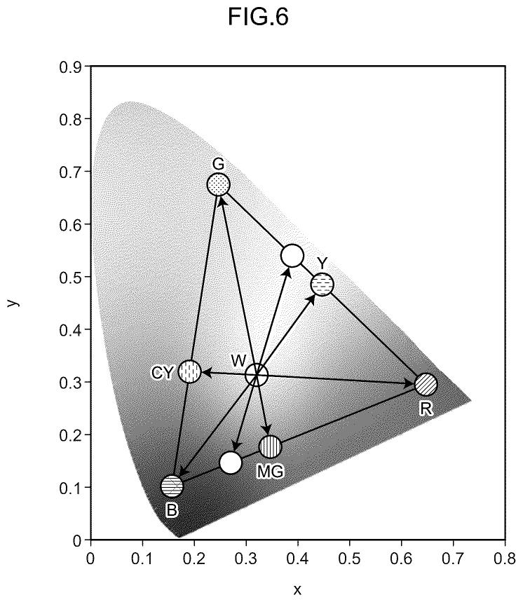

In the example illustrated in FIG. 5, a composite color of the light emission color of the backlight 30 during the first subframe period (first period) and the light emission color of the backlight 30 during the second subframe period (second period) is white, and thus the first image displayed on the first liquid crystal display panel 10 can be displayed in full color (16.77 million colors in the case of 256 gradations). The light emission colors of the backlight 30 during the first subframe period (first period) and the second subframe period (second period) in the second mode are not limited to the example illustrated in FIG. 5. FIG. 6 is a schematic diagram illustrating a specific example of the color gamut of the second image in the second mode.

As illustrated in FIG. 5, in a case where the light emission color of the backlight 30 during the first subframe period (first period) is set to yellow (Y) and the light emission color of the backlight 30 during the second subframe period (second period) is set to blue (B), the second image displayed on the second liquid crystal display panel 20 can be represented by a color gamut along a linear region passing through white (W) and connecting yellow (Y) and blue (B) as illustrated in FIG. 6.

Instead of the above description, for example, in a case where the light emission color of the backlight 30 during the first subframe period (first period) is set to red (R) and the light emission color of the backlight 30 during the second subframe period (second period) is set to cyan (CY), which is a composite color of blue (B) and green (G), the second image displayed on the second liquid crystal display panel 20 can be represented by a color gamut along a linear region passing through white (W) and connecting red (R) and cyan (CY) as illustrated in FIG. 6. Moreover, for example, in a case where the light emission color of the backlight 30 during the first subframe period (first period) is set to green (G) and the light emission color of the backlight 30 during the second subframe period (second period) is set to magenta (MG), which is a composite color of red (R) and blue (B), the second image displayed on the second liquid crystal display panel 20 can be represented by a color gamut along a linear region passing through white (W) and connecting green (G) and magenta (MG) as illustrated in FIG. 6.

Furthermore, for example, it is possible to freely set the color gamut of the second image that is displayed on the second liquid crystal display panel 20 by changing the ratio of the light emission quantities of light sources to be caused to emit light during each of the first subframe period (first period) and the second subframe period (second period). In this case, it is possible to display the first image displayed on the first liquid crystal display panel 10 in full color (16.77 million colors display in the case of 256 gradations) by setting the ratio of the light emission quantities of light sources to be caused to emit light during each of the first subframe period (first period) and the second subframe period (second period) such that a composite color of the light emission color of the backlight 30 during the first subframe period (first period) and the light emission color of the backlight 30 during the second subframe period (second period) is white (W). Moreover, it is possible to represent the second image, which is displayed on the second liquid crystal display panel 20, by a color gamut along a linear region passing through white (W) and connecting the light emission color of the backlight 30 during the first subframe period (first period) and the light emission color of the backlight 30 during the second subframe period (second period).

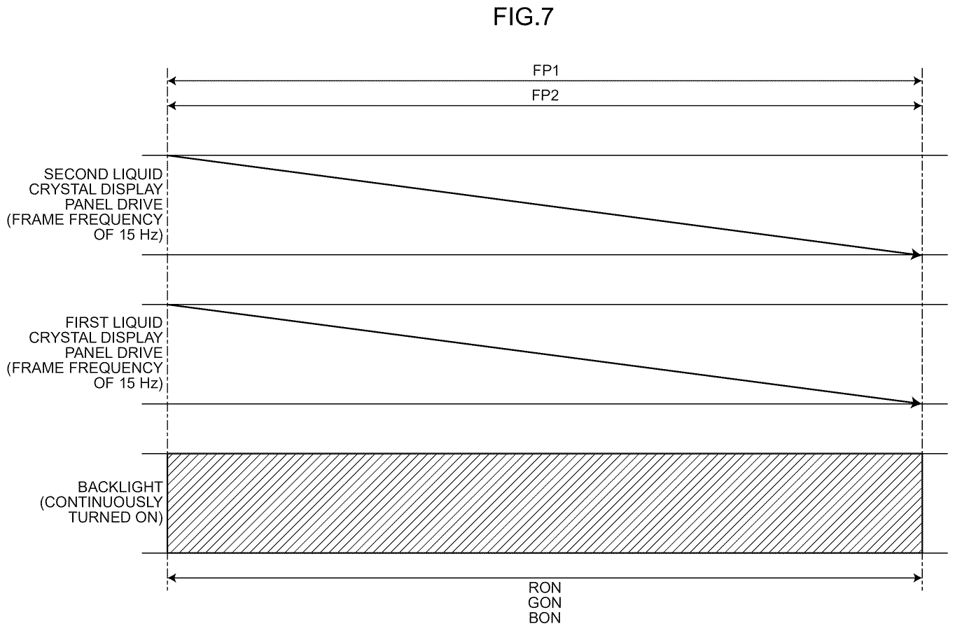

FIG. 7 is a timing chart illustrating an example of driving patterns of the first liquid crystal display panel, the second liquid crystal display panel, and the backlight in a third mode.

In the third mode illustrated in FIG. 7, each frame period FP1 during which the first image is displayed on the first liquid crystal display panel 10 includes one frame period FP2 during which the second image is displayed on the second liquid crystal display panel 20. In FIG. 7, one frame period FP1 during which the first image is displayed on the first liquid crystal display panel 10 coincides with one frame period FP2 during which the second image is displayed on the second liquid crystal display panel 20. In addition, both the frame frequency of the first liquid crystal display panel 10 and the frame frequency of the second liquid crystal display panel 20 are set to 15 Hz. Each frame period FP1 of the first liquid crystal display panel 10 and each frame period FP2 of the second liquid crystal display panel 20 are set to 66.7 ms. The frame frequency of the first liquid crystal display panel 10 and the frame frequency of the second liquid crystal display panel 20 are not limited to 15 Hz.

In the third mode illustrated in FIG. 7, the backlight 30 continuously emits light in a constant color during each frame period FP1 of the first liquid crystal display panel 10 (each frame period FP2 of the second liquid crystal display panel 20).

Throughout each frame period FP1, the control circuit 2 performs image data writing corresponding to the first image that is displayed on the first liquid crystal display panel 10. In addition, throughout each frame period FP2, the control circuit 2 performs image data writing corresponding to the second image that is displayed on the second liquid crystal display panel 20. Accordingly, one frame of the first image is displayed on the first liquid crystal display panel 10, and one frame of the second image is displayed on the second liquid crystal display panel 20.

FIG. 7 exemplifies an aspect in which the first light source 30R, the second light source 30G, and the third light source 30B are simultaneously caused to emit light during each frame period FP1 of the first liquid crystal display panel 10 (each frame period FP2 of the second liquid crystal display panel 20), and accordingly, light in white, which is a composite color of the first color (red (R)), the second color (green (G)), and the third color (blue (B)), is incident on the first liquid crystal display panel 10. With this configuration, the first image displayed on the first liquid crystal display panel 10 can be displayed in full color (16.77 million colors display in the case of 256 gradations), and the second image displayed on the second liquid crystal display panel 20 can be displayed in monochrome.

The light emission color of the backlight 30 in a case where the backlight 30 is caused to continuously emit light in the third mode is not limited to white. The light emission color of the backlight 30 in the third mode may be any of the first color (red (R)), the second color (green (G)), and the third color (blue (B)) or may be a composite color of a plurality of colors among the first color (red (R)), the second color (green (G)), and the third color (blue (B)).

The display device 1 according to the embodiment is provided with the first light source 30R that emits light in the first color (red (R)), the second light source 30G that emits light in the second color (green (G)), and the third light source 30B that emits light in the third color (blue (B)). Each frame period FP2 during which the second image is displayed on the second liquid crystal display panel 20 is time-divided into the first subframe period (first period) RF during which the first light source 30R is caused to emit light, the second subframe period (second period) GF during which the second light source 30G is caused to emit light, and the third subframe period (third period) BF during which the third light source 30B is caused to emit light. Thus, the second image can be displayed in full color (16.77 million colors in the case of 256 gradations) (first mode) without providing a color filter on the second liquid crystal display panel 20. With this configuration, it is possible to suppress decrease in the luminance of a displayed image, which is caused by decrease in transmittance. In addition, it is possible to suppress decrease in display power efficiency along with decrease in the luminance of the displayed image.

Moreover, it is possible to provide a plurality of modes by changing the light emission color of the backlight 30 and varying the light emission timings of the respective light emission colors as described above.

Specifically, for example, each frame period FP2 during which the second image is displayed on the second liquid crystal display panel 20 is divided into the first subframe period (first period) and the second subframe period (second period) between which the light emission color of the backlight 30 is different (the second mode). With this configuration, the second liquid crystal display panel 20 can be set to a lower panel drive frequency than in the first mode. In addition, the effect of suppressing decrease in display power efficiency can be enhanced along with the decrease in the panel drive frequency of the second liquid crystal display panel 20.

Moreover, one frame period FP1 during which the first image is displayed on the first liquid crystal display panel 10 and one frame period FP2 during which the second image is displayed on the second liquid crystal display panel 20 are set so as to coincide with each other, and the backlight 30 continuously emits light in a constant light emission color (the third mode). With this configuration, the panel drive frequency of the second liquid crystal display panel 20 can be set to a further lower frequency than in the second mode.

In this manner, a plurality of modes are switchable in which variation in the light emission color of the backlight 30 is combined with variation in the light emission timing of each light emission color. With this configuration, it is possible to set modes in accordance with functions, usage conditions, and the like.

A fourth mode in which the second liquid crystal display panel 20 is set to non-display to enhance the effect of reducing power consumption may be provided in addition to the above-described first, second, and third modes. In a case where the second liquid crystal display panel 20 is set to non-display, the second liquid crystal display panel 20 may continue driving with its frame frequency set to, for example, 1 Hz or lower, or may stop driving.

In the above description, the meter device 100 that is, for example, a wristwatch-type electronic apparatus such as a smartwatch, or an instrument panel installed in front of the driver seat of a vehicle such as an automobile is exemplified as the application of the display device 1. However, the examples of the application of the display device 1 are not limited thereto. Specifically, the display device 1 according to the embodiment may be applied to a head-up display (HUD), for example.

Preferable embodiments of the present disclosure are described above, but the present disclosure is not limited to such embodiments. Contents disclosed in the embodiments are merely exemplary, and various kinds of modifications are possible without departing from the scope of the present disclosure. For example, any modification performed as appropriate without departing from the scope of the present disclosure belongs to the technical scope of the present invention.

What is claimed is:

1. A display device comprising:
a backlight;
a first polarizing plate on which direct light from the backlight is incident and that transmits light polarized in a first direction and blocks light polarized in a direction different from the first direction;
a first liquid crystal display panel on which transmitted light from the first polarizing plate is incident;
a second liquid crystal display panel that overlaps the first liquid crystal display panel with a gap interposed between the first and second liquid crystal display panels and on which transmitted light from the first liquid crystal display panel is incident; and
a second polarizing plate on which transmitted light from the second liquid crystal display panel is incident and that transmits light polarized in a second direction different from the first direction and blocks light polarized in a direction different from the second direction, wherein
the backlight has a plurality of modes with different light emission timings respectively for a plurality of light emission colors,
the first liquid crystal display panel is provided with a first color filter that transmits first light, a second color filter that transmits second light different from the first light, and a third color filter that transmits third light different from the first light and the second light,
the second liquid crystal display panel is not provided with a color filter, and
no other polarizing plate is provided between the first liquid crystal display panel and the second liquid crystal display panel.

2. The display device according to claim 1, wherein the backlight has a first mode in which each frame period of the second liquid crystal display panel includes a period during which light in a first color is emitted, a period during which light in a second color different from the first color is emitted, and a period during which light in a third color different from the first color and the second color is emitted.

3. The display device according to claim 2, wherein
the first color is red,
the second color is green, and
the third color is blue.

4. The display device according to claim 1, wherein the backlight has a second mode in which each frame period of the second liquid crystal display panel includes a first period and a second period that are periods during which light is emitted in different colors, respectively.

5. The display device according to claim 4, wherein a composite color of a light emission color during the first period and a light emission color during the second period is white.

6. The display device according to claim 1, wherein the backlight has a third mode in which light in a predetermined light emission color is continuously emitted during each frame period of the first liquid crystal display panel.

7. The display device according to claim 1, wherein when viewed in at least one direction in which the first liquid crystal display panel and the second liquid crystal display panel are placed so as to overlap each other,
a display region in which image display is performed in the first liquid crystal display panel overlaps a non-display region in which image display is not performed in the second liquid crystal display panel, and
a non-display region in which image display is not performed in the first liquid crystal display panel overlaps a display region in which image display is performed in the second liquid crystal display panel.

8. The display device according to claim 7, wherein light having passed through the non-display region of the first liquid crystal display panel is incident on the display region of the second liquid crystal display panel.

9. The display device according to claim 1, wherein the length of each frame period of the second liquid crystal display panel is equal to or shorter than the length of each frame period of the first liquid crystal display panel.

10. The display device according to claim 1, wherein the backlight is configured to switch the modes between a first display period and a second display period that are periods during which different images are displayed, respectively.

11. A wristwatch-type electronic apparatus comprising the display device according to claim 1.

12. A vehicle instrument panel comprising the display device according to claim 1.
